(19) United States
(12) Patent Application Publication
(10) Pub. No.: US 2006/0091368 A1
(43) Pub. Date: May 4, 2006

(54) Winch bars

(76) Inventor: Darryl Im, Costa Mesa, CA (US)

Correspondence Address: Boniard I. Brown, 1730 West Cameron Avenue, #210, West Covina, CA, 91790, US

(21) Appl. No.: 10/979,517

(22) Filed: Nov. 1, 2004

(51) Int. Cl. B25B 25/00

(52) U.S. Cl. 254/218

(57) ABSTRACT

A winch bar has an insertion portion adapted to fit in openings of a winch drum of non-circular cross-section, whereby the winch bar cannot rotate relative to the openings to present hazards of injury to persons or property which can result with prior art circular drum openings and circular cross-section bars.

### RELATED APPLICATIONS

Reference is made to my co-pending application Ser. No. 10/228,443, filed Aug. 26, 2002, titled “Winch Bar”.

### BACKGROUND AND SUMMARY OF THE INVENTION

Winch apparatus has long been used to secure straps to retain loads and objects, as on trucks and trailers. A winch assembly is typically secured in a bracket which is typically welded or otherwise secured to a base, such as the bed of a truck trailer.

At least one strap is secured to a winch drum wherein registering openings are provided through-which the winch bar extends. The winch bar is manually operated to rotate the drum to tighten the strap or straps to retain an object or load.

A long standing problem has been unintentional or undesirable rotation of the winch bar elongate handle portion in the drum openings when the bar is not manually held or otherwise retained. With such rotation, which is typically in a conical path because of an angle between an insertion portion of the bar and its elongate handle portion. Hazards to persons and property thus result, and there has been a history of many injuries to persons and property caused by the freely rotating winch bar in such conical path.

The present invention eliminates such hazardous rotation of a winch bar in the opening of a winch drum. The winch drum openings comprise at least one pair of openings in diametrically opposite positions in an annular winch drum member. The openings are typically polygonal, hexagonal or square, so that the winch bar cannot rotate relative to the drum member.

### BRIEF DESCRIPTION OF THE DRAWINGS

FIG. 1 is an elevational view of a winch bar according to the invention in relation to a winch winding drum;

FIG. 2 is a perspective view of a winch bar invention in operational assembly with a winch;

FIG. 3 is a sectional view taken at line 3-3 in FIG. 2;

FIG. 4 is a partial perspective view showing two ratchet drive winch assemblies mounted on a truck bed and secured by straps extending therefrom;

FIG. 5 is a partial perspective view of a winch bar of the invention in operative relation with a ratchet drive winch and a binding strap; and

FIGS. 6 through 16 each show the configurations of a respective winch bar insertion portion according to the present invention.

### DESCRIPTION OF THE PREFERRED EMBODIMENTS

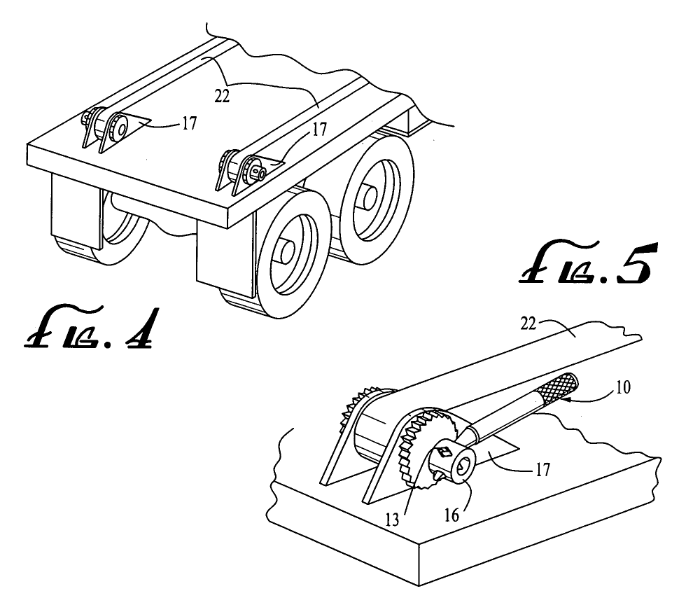

Referring to the drawings, a winch bar 10 according to the invention has a cross-sectional end portion 13 configuration adapted to fit in and extend through diametrically opposite openings 15 in a drum 16. The drum is rotatably mounted in a bracket 17 welded to a truck bed or other structure, and has spaced-apart openings 15, as shown, to receive a mandrel 18 having thereon a slot 20 to receive a strap 22. The bracket 17 is shown in FIGS. 4 and 5 as comprising two members welded to a truck bed surface. The ratchet mechanism 24, partially shown in FIG. 2, is conventional and is not illustrated or described in detail. One or two straps are preferably wound twice about the mandrel to prevent slippage, which can result in problems and damage. Each strap extends about an object or item (not shown) to be retained, as on a freight truck or trailer.

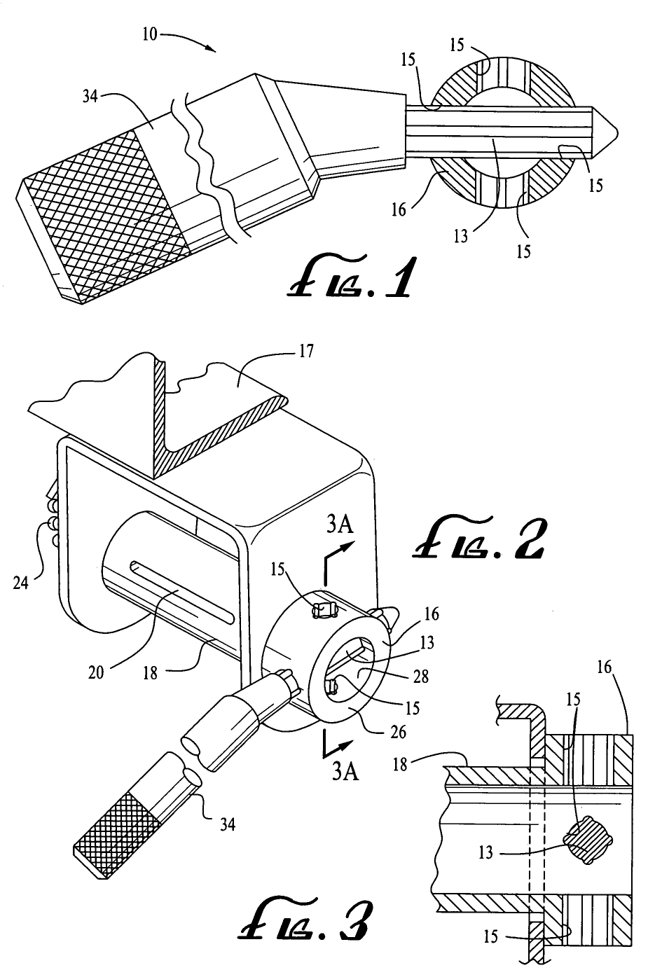

The winch bar is insertable through and fits in the diametrically opposed openings 15 (FIG. 1), as shown. The winch bar has a tapered end portion to facilitate insertion and handling. The drum has an annular wall member 26, a large central opening 28, and a plurality of pairs of diametrically opposed openings. The openings may be of any various configurations corresponding to cross-sectional configurations of respective winch bars. The winch bar has respective cross-sectional configurations of its insertion portion, which correspond to respective opening configurations.

The winch bar preferably has its elongate handle or bar portion 34 disposed at an arcuate angle relative to its insertion portion 13, as shown in FIGS. 1 and 2. The handle portion is preferably knurled as indicated in FIG. 2 in order to better provide for better manual gripping. Another type of highly frictional surface may be provided. The drum 16 is rotatable by manual operation of the winch bar, pulling on the bar tightening the strap or straps 22 (FIGS. 4 and 5) which are secured in tightened position by the ratchet mechanism to secure and retain an object or load (not shown) on a truck bed or other surface.

Accidents and injuries to persons have occurred because of conventional circular openings in the winding drum to receive the winch bar. Because of the angular inclination of the handle portion of the winch bar relative to the insertion end portion 13 thereof, the winch bar end portion rotates in the drum openings in a generally conical pattern. In such a swinging arc, the handle portion 34 of a winch bar can strike objects and persons. Many injuries have resulted from such accidental free rotational conical motion of the winch bar.

As stated earlier, respective winches and corresponding respective winch openings may have other embodiments or forms than those of Applicant's earlier parent application, and other than the winch bar insertion end portion 13 and opening 15 of FIGS. 1 and 2.

FIGS. 6 through 16 illustrate respective cross-sections of winches and their respective corresponding or mating winch openings. The drawings illustrate both the cross-sectional configuration of each respective winch and the cross-section of the mating winch opening.

FIG. 6 shows a circular configuration with equally spaced small semi-circular projections extending therefrom;

FIG. 7 shows a generally circular configuration with four equally spaced square corner projections extending thereabout.

FIG. 8 shows a circular configuration with two oppositely extending rectangular projections.

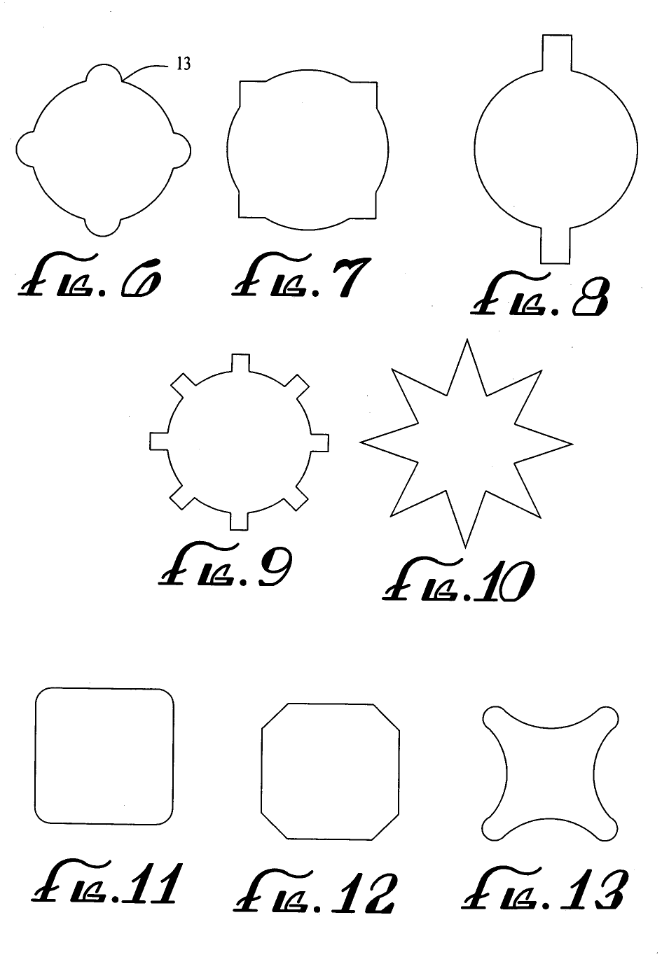

FIG. 9 shows a generally circular configuration with a plurality of eight rectangular projections equally spaced apart extending the periphery of the circle.

FIG. 10 shows a configuration of an eight pointed star.

FIG. 11 is a generally square configuration with corners rounded.

FIG. 21 is a generally square configuration with corners cut-away at 45° angles.

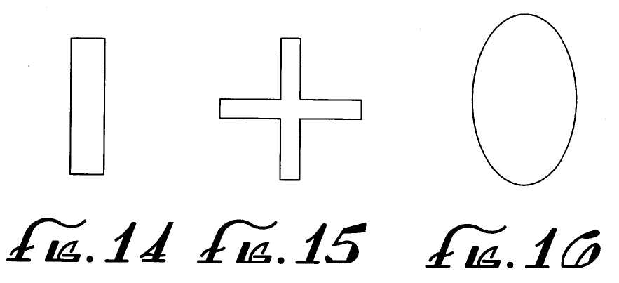

FIG. 13 is a configuration comprising four concave sides with four rounded outer knob portions equally spaced at each corner defining four rounded projections.

FIG. 14 shows an elongate rectangular configuration.

FIG. 15 is a configuration comprising a cross of four rectilinear arms of equal lengths.

FIG. 16 shows an oval configuration.

It will be understood that various changes and modifications may be made from the preferred embodiments discussed above without departing from the scope of the present invention, which is established by the following claims and equivalents thereof.

1. A winch bar and winch winding drum combination, comprising:
a winch bar insertion portion having a cross-sectional configuration and size to fit through openings in a winch winding drum,
an elongate handle of the winch bar for manipulation to rotate the winch winding drum to exert tensioning force on a retaining strap secured on the winding drum to retain objects, whereby with said winch bar engaged in similarly configured diametrically opposite ones of said openings of the winch winding drum relative rotation is prevented between the winch bar and the winch winding drum to prevent the winch bar from swinging about the winch winding drum in a generally conical pattern to prevent injuries to persons and damage to property.

2. A combination according to claim 1 wherein said cross-sectional configuration of said winch bar and said opening in the winch winding drum comprises a generally circular configuration with equally spaced small semi-circular projections extending therefrom.

3. A combination according to claim 1 wherein said cross-sectional configuration of said winch bar and said opening in the winch winding drum comprises a generally circular configuration with four equally spaced square corner projections extending thereabout.

4. A combination according to claim 1 wherein said cross-sectional configuration of said winch bar and said opening in the winch winding drum comprises a circular configuration with two oppositely extending rectangular projections.

5. A combination according to claim 1 wherein said cross-sectional configuration of said winch bar and said opening in the winch winding drum comprises a generally circular configuration with a plurality of eight rectangular projections equally spaced apart extending the periphery of the circle.

6. A combination according to claim 1 wherein said cross-sectional configuration of said winch bar and said opening in the winch winding drum comprises a configuration of an eight pointed star.

7. A combination according to claim 1 wherein said cross-sectional configuration of said winch bar and said opening in the winch winding drum comprises a generally square configuration with corners rounded.

8. A combination according to claim 1 wherein said cross-sectional configuration of said winch bar and said opening in the winch winding drum comprises a generally square configuration with corners cut-away at 45° angles.

9. A combination according to claim 1 wherein said cross-sectional configuration of said winch bar and said opening in the winch winding drum comprises four concave sides with four rounded outer knob portions equally spaced at each corner defining four rounded projections.

10. A combination according to claim 1 wherein said cross-sectional configuration of said winch bar and said opening in the winch winding drum comprises an elongate rectangular configuration.

11. A combination according to claim 1 wherein said cross-sectional configuration of said winch bar and said opening in the winch winding drum comprises a configuration comprising a cross of four rectilinear arms of equal lengths.

12. A combination according to claim 1 wherein said cross-sectional configuration of said winch bar and said opening in the winch winding drum comprises an oval configuration.

13. A winch bar and winch winding drum combination, comprising:
a winch bar insertion portion having a cross-sectional configuration adapted to fit in diametrically opposite openings of similar cross-sectional configurations in a winch winding drum having an annular wall member,
an elongate handle of the winch bar for manipulation to rotate the winch winding drum to exert tension force on a retaining strap secured on the winding drum to retain objects, whereby with said winch bar insertion portion engaged in the diametrically opposed and similarly configured openings of the winch winding drum relative rotation is prevented between the winch bar and the winding drum openings to prevent personal injury by the winch bar.

14. A combination according to claim 13 wherein said winch bar has its elongate handle disposed at an acute angle relative to its end insertion portion.

15. A combination according to claim 13 wherein said drum is rotatable by operation of the winch bar and has an end portion tapered to facilitate insertion into said openings in the drum.
